(19) United States
(12) Patent Application Publication
(10) Pub. No.: US 2026/0368253 A1
(43) Pub. Date: Nov. 19, 2026

(54) KNOWLEDGE MANAGEMENT SYSTEM AND DATA CONNECTION METHOD

(71) Applicant: Hitachi, Ltd., Tokyo (JP)

(72) Inventors: Tomoki KASAI, Tokyo (JP); Keiro MURO, Tokyo (JP); Riku KAWAMURA, Tokyo (JP); Hitoshi ISHIDA, Tokyo (JP); Takehiro HAGIWARA, Tokyo (JP); Yuichiro AOKI, Tokyo (JP)

(21) Appl. No.: 19/539,719

(22) Filed: Feb. 13, 2026

(30) Foreign Application Priority Data
May 16, 2025 (JP) 2025-082775

(51) Int. Cl. G06F 16/901; G06Q 10/10

(52) U.S. Cl. CPC G06F 16/9024; G06Q 10/10

(57) ABSTRACT

A processor receives inputs of a first data group and a second data group, executes a first analysis process that analyzes a first inclusion relationship possessed by the first data group, executes a second analysis process that associates the first data group, in which the first inclusion relationship has been analyzed, with the second data group, executes a third analysis process that analyzes a second inclusion relationship in the second data group based on the first inclusion relationship and a correspondence established by the second analysis process, and executes a first connection process that connects a new relationship between (i) the second data group included by the second inclusion relationship analyzed by the third analysis process and (ii) the second data group associated with the first data group including the first inclusion relationship analyzed by the first analysis process.

### CROSS REFERENCE TO RELATED APPLICATIONS

This application claims priority to Japanese Patent Application No. 2025-082775, filed May 16, 2025, the contents of which are incorporated herein by reference in its entirety for all purposes.

### TECHNICAL FIELD

The present disclosure relates to a knowledge management system and a data connection method.

### BACKGROUND

In the manufacturing industry, data relating to failures that have occurred in past manufacturing processes is important, as such data provides clues for resolving similar failures when they recur.

Conventionally, data regarding failures that actually occurred in the past, as well as data concerning failures anticipated in advance, has been accumulated in a database. By referring to such data, attempts have been made to resolve failures arising in manufacturing processes.

As a method for storing data in a database, there exists a method in which failure-related information—specifically, symptoms, causes, and countermeasures implemented to resolve the failures—is managed using a graph structure referred to as a knowledge graph.

Managing failure-related data as a knowledge graph enables comprehensive searching of potential causes corresponding to a failure symptom and countermeasures capable of resolving the symptom, thereby contributing to the identification of clues for failure resolution.

### SUMMARY

### Problem to be Solved

As failure-related data necessary for constructing a knowledge graph, failure reports prepared by workers at the time of occurrence of past failures can be considered.

Among failure reports, multiple reports exist in which similar symptoms are described using different expressions. For example, with respect to similar failure symptoms A and B, there may be a report stating that symptom A was resolved by countermeasure C, and another report stating that symptom B was resolved by countermeasure D. When symptoms A and B are similar, there is a possibility that symptom A may also be resolved by countermeasure D, and that symptom B may also be resolved by countermeasure C. Accordingly, it is desirable to construct a knowledge graph that assigns relationships not only between symptom A and countermeasure C, and between symptom B and countermeasure D, but also between symptom A and countermeasure D, and between symptom B and countermeasure C.

However, it is difficult for a human to review all failure reports, which exist in large quantities, and to construct a knowledge graph while taking into account such variations in expression.

Japanese Unexamined Patent Application Publication No. 2009-289020 describes a program configured to “integrate nodes based on similarity between the nodes to generate an FT diagram.” The program disclosed in the publication calculates similarities between nodes of causal relationship subtrees, component subtrees, and functional subtrees, and discloses that a highly reliable FT diagram can be generated at low cost by integrating similar nodes.

As a method for estimating similar expressions without requiring a human to manually review the entirety of failure reports, as in the publication, estimation based on sentence similarity can be considered. However, when the causal relationship between symptom and countermeasure is unknown, estimation based on sentence similarity cannot determine that descriptions written in different expressions actually refer to the same failure symptom or countermeasure. For example, a symptom described as “Error Code: 1000” and a symptom described as “the indicator light does not turn on,” which is the phenomenon represented by the error code, are expressed differently but refer to the same symptom. Sentence-similarity estimation cannot determine these descriptions to be similar.

Another issue in constructing a knowledge graph lies in extracting synonymous yet different entity expressions (“synonymous entity expressions”). In this technique, a method is proposed in which information on countermeasures related to failure symptoms is utilized to determine synonymous entity expressions of failure symptoms; however, no method is disclosed regarding knowledge-graph construction after extraction of such synonymous expressions. Therefore, conventional techniques have lacked an approach capable of estimating inclusion relationships among data and, based on the estimated inclusion relationships, connecting data in a manner that enables broader retrieval of related data.

The present disclosure has been made in view of the above circumstances. An object of the present disclosure is to estimate, from contents of failure symptoms and countermeasures described in a large number of failure reports, inclusion relationships among failure symptoms and inclusion relationships among countermeasures, and to enable comprehensive searching for potential causes corresponding to a failure symptom and countermeasures capable of resolving the symptom by connecting new relationships to failure-symptom-related and countermeasure-related data based on the estimated inclusion relationships.

A knowledge management system according to the present disclosure is a knowledge management system for performing knowledge management by a computer comprising a processor and a memory. The processor is configured to receive inputs of a first data group and a second data group, execute a first analysis process for analyzing a first inclusion relationship possessed by the first data group, execute a second analysis process for associating the first data group—having the first inclusion relationship analyzed—with the second data group, and execute a third analysis process for analyzing a second inclusion relationship in the second data group based on the first inclusion relationship and the association obtained through the second analysis process. The processor is further configured to execute a first connection process for connecting a new relationship between (i) the second data group that is included by the second inclusion relationship analyzed through the third analysis process, and (ii) the second data group associated, through the first inclusion relationship analyzed through the first analysis process, with the first data group that includes the second data group.

According to the present disclosure, related data can be searched over a wider range by estimating inclusion relationships among data and connecting data while taking the inclusion relationships into account.

### BRIEF DESCRIPTION OF THE DRAWINGS

FIG. 1A is an example of a block diagram illustrating functional components of a knowledge management system for data connection according to Embodiment 1.

FIG. 1B is an example of a diagram illustrating an outline of a computer constituting the knowledge management system illustrated in FIG. 1A.

FIG. 2 is an example of failure reports stored in a data storage unit according to the embodiment.

FIG. 3 is an example of a design document related to requirements stored in the data storage unit according to the embodiment.

FIG. 4 is an example of a design document related to components stored in the data storage unit according to the embodiment.

FIG. 5 is an example of a failure knowledge graph stored in the data storage unit according to the embodiment.

FIG. 6 is an example of a diagram illustrating operations of the knowledge management system according to Embodiment 1.

FIG. 7 is an example of a flowchart illustrating estimation of inclusion relationships and a data-connection process according to Embodiment 1.

FIG. 8 is an example of connection between requirements and symptoms according to Embodiment 1.

FIG. 9 is an example of estimation of symptom inclusion relationships according to Embodiment 1.

FIG. 10 is an example of connection between countermeasures and components according to Embodiment 1.

FIG. 11 is an example of estimation of countermeasure inclusion relationships according to Embodiment 1.

FIG. 12 is an example of connection between symptoms and countermeasures according to Embodiment 1.

FIG. 13 is an example of connection between symptoms and countermeasures when symptom nodes have three hierarchical levels according to Embodiment 1.

FIG. 14 is an example of connection between symptoms and countermeasures when countermeasure nodes have three hierarchical levels according to Embodiment 1.

FIG. 15 is an example of a screen presenting results of symptom-countermeasure connections according to Embodiment 1.

FIG. 16 is a diagram illustrating creation of a relationship matrix according to Embodiment 1.

FIG. 17 is an example of clustering according to Embodiment 1.

FIG. 18 is an example of a screen presenting results of symptom-countermeasure clustering according to Embodiment 1.

FIG. 19 is an example of a screen in which a user searches for failure symptoms and corresponding countermeasures using symptom-countermeasure clustering results according to Embodiment 1.

FIG. 20 is an example of a screen presenting results of symptom-countermeasure connections according to Embodiment 2.

FIG. 21 is an example of a screen in which failure symptoms and corresponding countermeasures are searched using symptom-countermeasure node-connection results according to Embodiment 2.

### DETAILED DESCRIPTION OF EMBODIMENTS

Embodiments of the present disclosure will be described below with reference to the drawings. The embodiments are presented by way of example for illustrating the present disclosure, and, for the purpose of clarifying the description, omissions and simplifications are made as appropriate. The present disclosure may be implemented in various other forms. Unless otherwise specified, each component may be singular or plural. The positions, sizes, shapes, ranges, and the like of components illustrated in the drawings may not represent the actual positions, sizes, shapes, or ranges, but may be provided to facilitate understanding of the disclosure. Therefore, the present disclosure is not necessarily limited to the positions, sizes, shapes, or ranges disclosed in the drawings.

Examples of various types of information may be described using representations such as “table,” “list,” or “queue.” However, the various types of information may be represented using data structures other than these. For example, information described as “XX table,” “XX list,” or “XX queue” may alternatively be referred to as “XX information.” When describing identification information, expressions such as “identification information,” “identifier,” “name,” “ID,” or “number” may be used, and these expressions may be substituted for one another.

When multiple components having the same or similar functions are present, the same reference numeral may be used with different subscripts for explanation. When it is unnecessary to distinguish among these components, the subscripts may be omitted.

In the embodiments, processing performed by executing a program may be described. A computer executes a program by means of a processor (e.g., a CPU or GPU) and performs processing defined by the program while using memory resources (e.g., memory) and interface devices (e.g., communication ports). Therefore, the processor may be the entity that performs the processing by executing the program. Likewise, the entity that performs the processing by executing the program may be a controller, apparatus, system, computer, or node that includes a processor. The entity performing the processing by executing the program may be any arithmetic unit and may include dedicated circuitry for performing specific processing. The dedicated circuitry may be, for example, an FPGA (Field Programmable Gate Array), an ASIC (Application Specific Integrated Circuit), or a CPLD (Complex Programmable Logic Device).

A program may be installed into a computer from a program source. The program source may be, for example, a program distribution server or a computer-readable storage medium. When the program source is a program distribution server, the server may include a processor and a storage resource storing a program to be distributed, and the processor of the server may distribute the program to another computer. In the embodiments, two or more programs may be implemented as a single program, or a single program may be implemented as two or more programs.

Embodiments will now be described below with reference to the drawings.

### Embodiment 1

In the present embodiment, a knowledge management system for estimating inclusion relationships among data (e.g., parent-child relationships between data) and connecting data is described by taking, as an example, the case where the system is applied to failure symptoms and countermeasures described in failure reports related to in-process failures in the manufacturing industry. However, the system may also be applied to failure symptoms and failure causes in the manufacturing industry, failure-related data described in failure reports generated outside the manufacturing process, and data used in maintenance operations across various industries. As described in detail below, the above-described issues can be addressed by including (i) processing for connecting new relationships among data based on inclusion relationships among data—namely, processing for connecting multiple pieces of data that are subjects of inclusion-relationship estimation with data related to each of the subject data, (ii) processing for estimating inclusion relationships of target data based on inclusion relationships of data related to the target data, and (iii) processing for connecting data related to the target data based on the estimated inclusion relationships among the target data.

### System Configuration

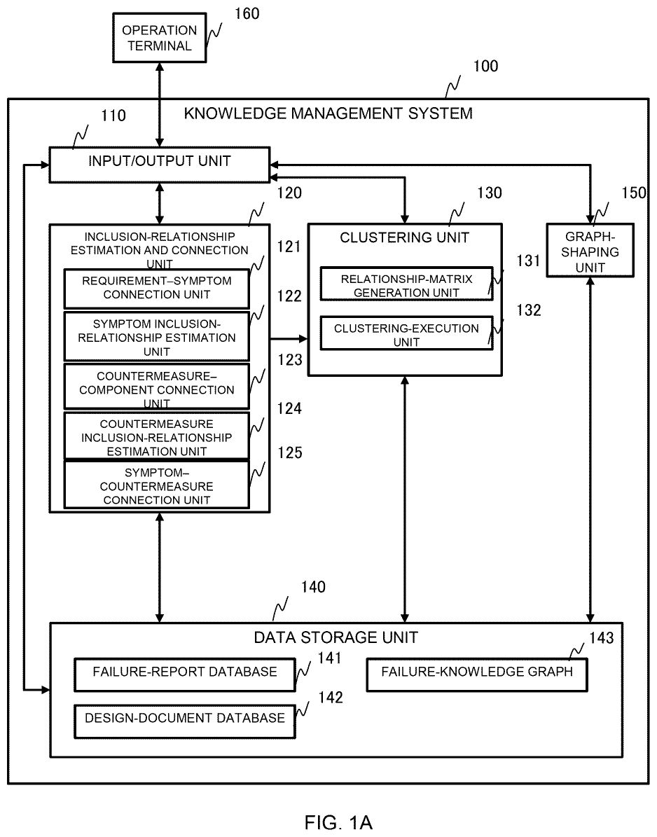

FIG. 1A is an example of a block diagram illustrating functional components of a knowledge management system according to the embodiment. As shown in FIG. 1A, a knowledge management system 100 includes an input/output unit 110, an inclusion-relationship estimation and connection unit 120, a clustering unit 130, a data storage unit 140, and a graph-shaping unit 150.

The knowledge management system 100 is connected to an operation terminal 160 via the input/output unit 110. The operation terminal 160 provides a user with an environment for inputting predetermined information into the inclusion-relationship estimation and connection unit 120, the clustering unit 130, the data storage unit 140, and the graph-shaping unit 150.

The inclusion-relationship estimation and connection unit 120 includes a requirement-symptom connection unit 121, a symptom inclusion-relationship estimation unit 122, a countermeasure-component connection unit 123, a countermeasure inclusion-relationship estimation unit 124, and a symptom-countermeasure connection unit 125.

The clustering unit 130 includes a relationship-matrix generation unit 131 and a clustering execution unit 132.

The data storage unit 140 includes a failure-report database 141, a design-document database 142, and a failure knowledge graph 143.

The knowledge management system 100 illustrated in FIG. 1A may be implemented by a general-purpose computer 1600A including, for example, a CPU 1601, a memory 1602, an external storage device 1603 such as an HDD (Hard Disk Drive), a read/write device 1607 that reads from and writes to a portable storage medium 1608 such as a CD (Compact Disk) or USB memory, an input device 1606 that receives various types of input information such as from a keyboard, mouse, reader, or scanner, an output device 1605 such as a display that outputs various types of information that have been input and used for processing, a communication device 1604 such as an NIC (Network Interface Card) for connecting to a communication network, and an internal communication line 1609, such as a system bus, that interconnects these components.

Various types of data stored in the system or used in processing may be implemented by the CPU 1601 reading and utilizing the data from the memory 1602 or the external storage device 1603. The functions provided by the system may also be implemented by the CPU 1601 loading into the memory 1602 and executing a predetermined program stored in the external storage device 1603.

The predetermined program and data described above may be stored (downloaded) into the external storage device 1603 from the storage medium 1608 via the read/write device 1607, or from a network via the communication device 1604, and thereafter loaded into the memory 1602 to be executed by the CPU 1601. Alternatively, the program and data may be loaded directly into the memory 1602 from the storage medium 1608 via the read/write device 1607 or from the network via the communication device 1604, and then executed by the CPU 1601.

### Data Content

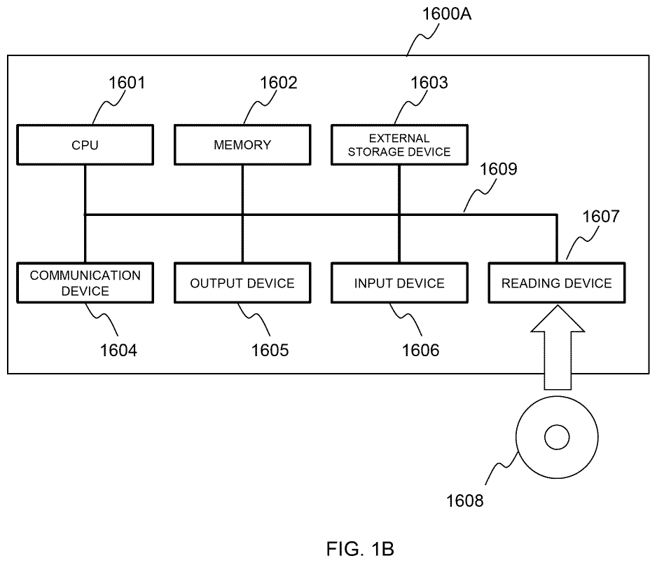

FIG. 2 is an example of failure reports stored in the failure-report database 141. A failure report 200 (example of a failure report) includes text data describing, in natural language, the symptoms of a failure, the causes, and the countermeasures that were implemented.

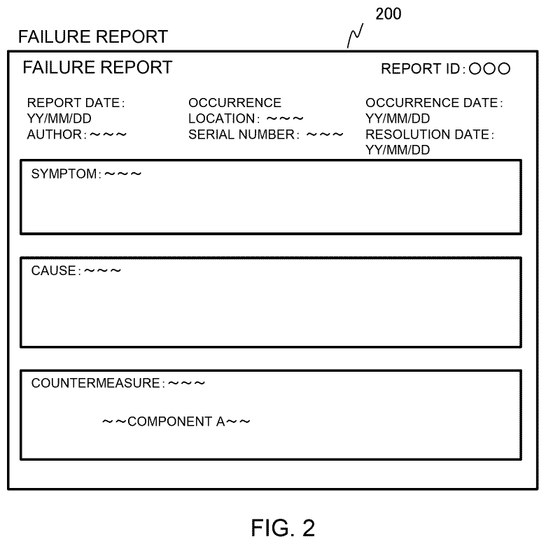

FIG. 3 is an example of requirement data stored in the design-document database 142. Requirement data 300 (example of a design document concerning requirements) includes a requirement list that structures specifications required of a product, and an assumed symptom list describing symptoms of failures presumed to occur when each requirement is not satisfied. For example, when requirement A is satisfied by fulfilling requirement B and requirement C, the inclusion relationship between requirement A and requirements B and C is represented as shown in FIG. 3.

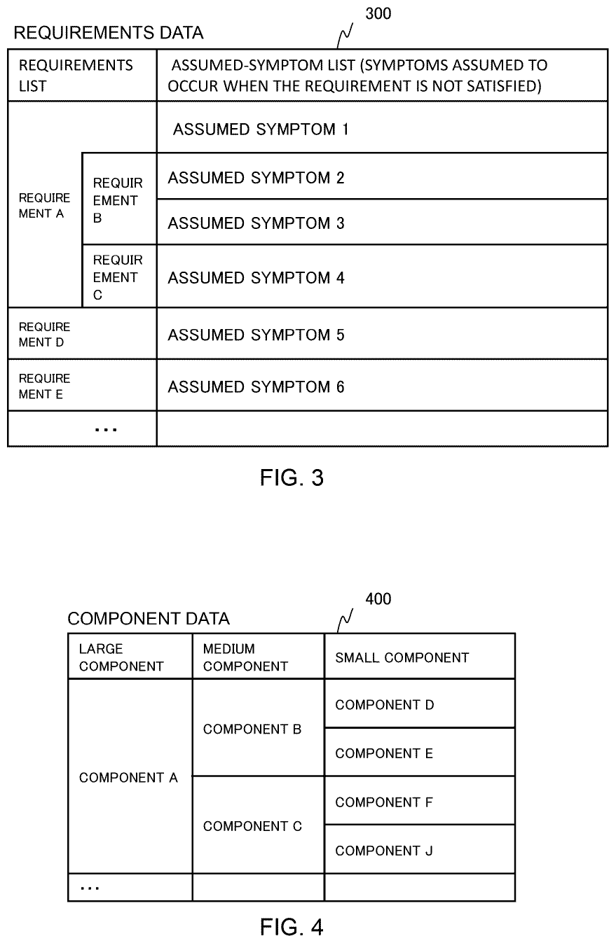

FIG. 4 is an example of component data stored in the design-document database 142. Component data 400 (example of a design document concerning components) represents structured data describing the component structure of a product. For example, when component A is composed of component B and component C, the inclusion relationship between the components is represented as shown in FIG. 4.

### Construction of Failure Knowledge Graph

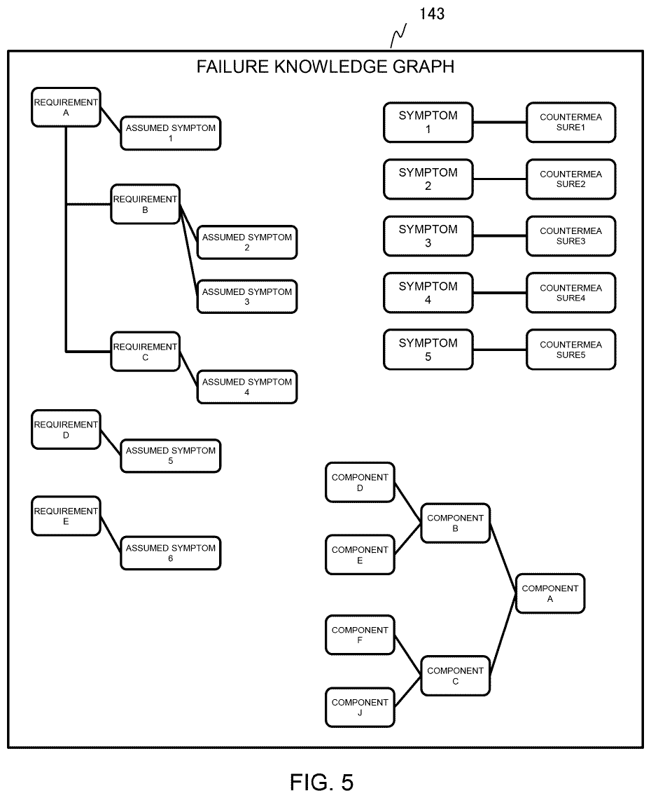

The graph-shaping unit 150 extracts data related to symptoms and countermeasures from failure reports stored in the failure-report database 141, and generates symptom nodes, countermeasure nodes, and edges between corresponding symptom nodes and countermeasure nodes. The graph-shaping unit 150 generates requirement nodes, edges representing inclusion relationships among requirements, assumed symptom nodes, and edges representing relationships between requirements and assumed symptoms from the requirement data. The graph-shaping unit 150 generates component nodes and edges representing inclusion relationships among components from the component data. The graph-shaping unit 150 stores, in the failure knowledge graph 143, the generated symptom nodes, countermeasure nodes, edges between corresponding symptom nodes and countermeasure nodes, requirement nodes, edges representing inclusion relationships among requirements, assumed symptom nodes, edges representing relationships between requirements and assumed symptoms, component nodes, and edges representing inclusion relationships among components as a graph structure. FIG. 5 is an example of the failure knowledge graph stored in the data storage unit according to the embodiment.

### Operation Procedure

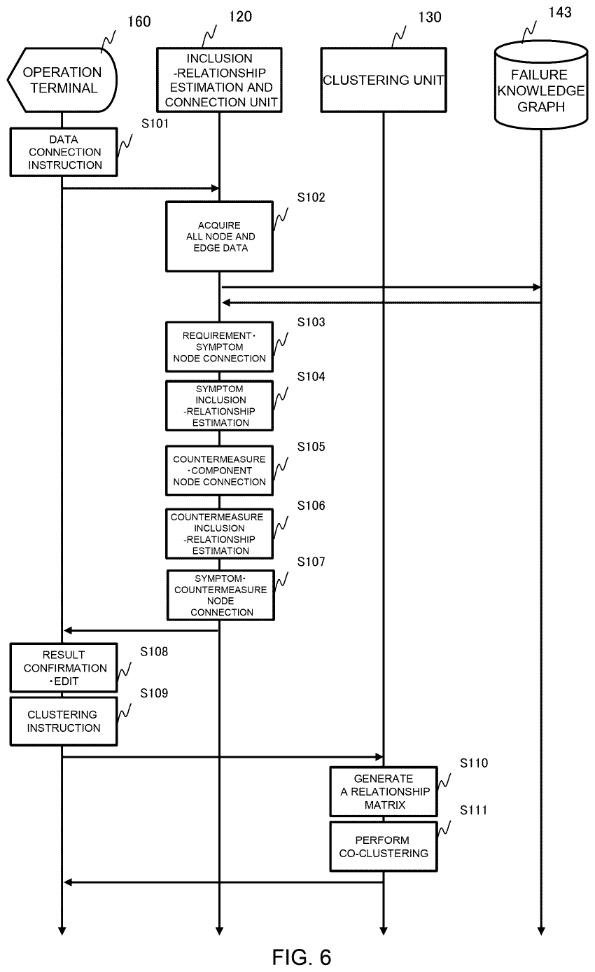

FIG. 6 is an example of a diagram illustrating operations of the knowledge management system 100 according to Embodiment 1.

A user of the knowledge management system 100 issues an instruction for data connection to the inclusion-relationship estimation and connection unit 120 using the operation terminal 160 (S101).

Next, the inclusion-relationship estimation and connection unit 120 acquires all node and edge data stored in the failure knowledge graph 143 (S102).

At this time, conditions may be imposed on the data to be acquired, such as acquiring only symptom nodes and countermeasure nodes that occurred during a particular period or for a particular product. Such conditions may also be specified by the user via the operation terminal 160.

Next, the inclusion-relationship estimation and connection unit 120 generates edges between requirement nodes and symptom nodes (S103).

Next, the inclusion-relationship estimation and connection unit 120 estimates inclusion relationships among symptoms based on the edges created between the requirement nodes and the symptom nodes (S104).

Next, the inclusion-relationship estimation and connection unit 120 generates edges between countermeasure nodes and component nodes (S105).

Next, the inclusion-relationship estimation and connection unit 120 estimates inclusion relationships among countermeasures based on the edges created between the countermeasure nodes and the component nodes (S106).

S103 and S104, and S105 and S106, are not necessarily required to be executed in this order. For example, the inclusion relationships among countermeasures may be estimated first in S105 and S106, followed by estimation of inclusion relationships among symptoms in S103 and S104. Alternatively, S103 and S104 and S105 and S106 may be executed in parallel.

The inclusion-relationship estimation and connection unit 120 generates edges between symptom nodes and countermeasure nodes based on the estimated inclusion relationships among symptoms and the estimated inclusion relationships among countermeasures, and outputs the results to the operation terminal 160 (S107).

The user of the knowledge management system 100 checks the data-connection results output in S107 using the operation terminal 160 (S108). During this process, the operation terminal 160 may receive edits from the user, including additions or deletions of edges.

Next, the user of the knowledge management system 100 instructs the clustering unit 130, via the operation terminal 160, to perform clustering of symptoms and countermeasures, and issues this instruction to the clustering unit 130 (S109).

Next, the clustering unit 130 generates a relationship matrix from the edges between the symptom nodes and the countermeasure nodes (S110).

Next, the clustering unit 130 performs co-clustering based on the relationship matrix and outputs the clustering results to the operation terminal 160 (S111).

### Inclusion-Relationship Estimation and Data-Connection Processing

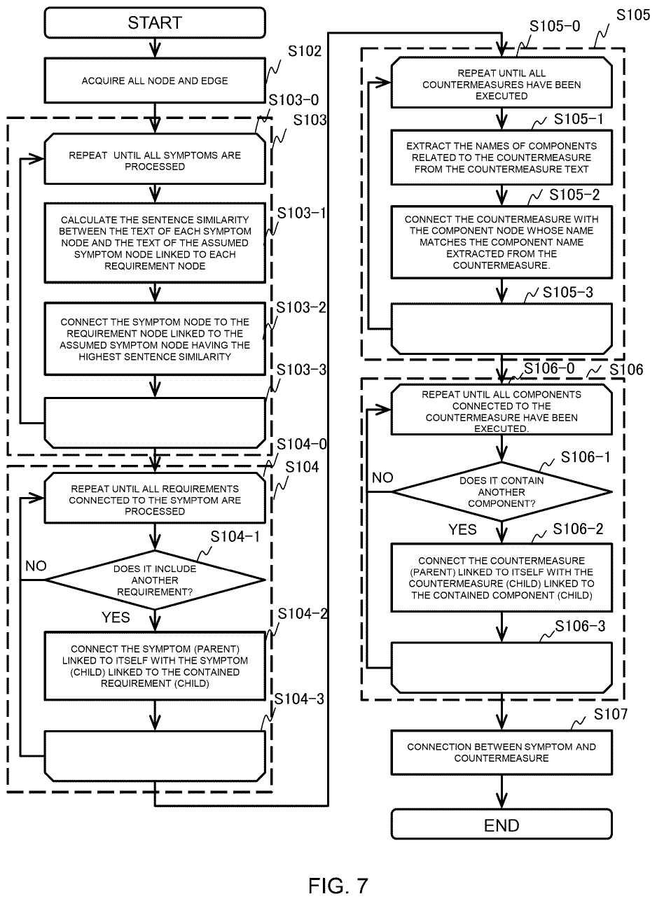

FIG. 7 is an example of a flowchart illustrating inclusion-relationship estimation and data-connection processing according to Embodiment 1. The procedure shown in FIG. 7 corresponds to steps S102 through S107 in the operation procedure illustrated in FIG. 6.

In step S102, the inclusion-relationship estimation and connection unit 120 acquires data for all nodes and edges from the failure knowledge graph 143, as illustrated in FIG. 5.

In step S103, the requirement-symptom connection unit 121 first calculates the sentence similarity between the text of each symptom node and the text of each assumed symptom node associated with the requirement nodes (S103-1).

Next, the requirement-symptom connection unit 121 connects the symptom node to the requirement node that is connected to the assumed symptom node having the highest sentence similarity score (S103-2).

This processing is repeated for all symptom nodes, thereby connecting all acquired symptom nodes to one of the requirement nodes (S103-0, S103-3).

Here, a user may set a threshold value for the sentence-similarity score, and all requirement nodes whose similarity score exceeds the threshold may be connected to the symptom node.

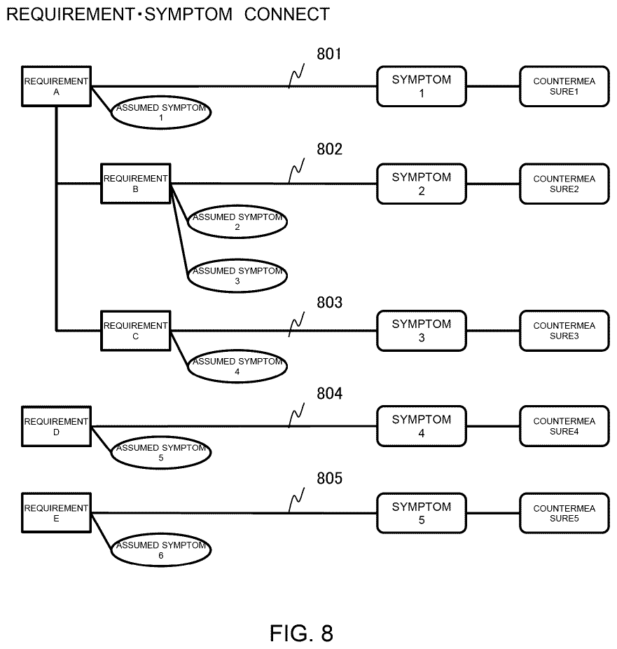

FIG. 8 is an example illustrating the connection between requirements and symptoms executed in step S103 according to Embodiment 1. FIG. 8 shows an example in which the text of symptom 1 has the highest sentence similarity with assumed symptom 1, symptom 2 with assumed symptom 2, symptom 3 with assumed symptom 4, symptom 4 with assumed symptom 5, and symptom 5 with assumed symptom 6. In this case, in step S103, the symptom 1 node is connected to the requirement A node, the symptom 2 node to the requirement B node, the symptom 3 node to the requirement C node, the symptom 4 node to the requirement D node, and the symptom 5 node to the requirement E node, respectively, via edges 801, 802, 803, 804, and 805 shown in FIG. 8.

Here, as a method for connecting symptoms and assumed symptoms, the texts of symptoms 1-5 and assumed symptoms 1-5 may be input as prompts to a generative AI, and the generative AI may connect related symptoms and assumed symptoms based on its learned knowledge. As the generative AI, any conventionally known generative AI, including RAG (Retrieval-Augmented Generation), may be used.

In step S104, the symptom inclusion-relationship estimation unit 122 detects, among the requirement nodes connected to the symptom nodes in step S103, requirement nodes that include other requirement nodes and requirement nodes that are included by other requirement nodes. A requirement node that includes another requirement node is treated as a parent, and a requirement node included by another requirement node is treated as a child.

The symptom inclusion-relationship estimation unit 122 determines whether a requirement node (parent) includes another requirement node. When the requirement node (parent) is determined to include another requirement node, the symptom inclusion-relationship estimation unit 122 connects the symptom node connected to the parent requirement node to the symptom node connected to the child requirement node.

The symptom inclusion-relationship estimation unit 122 treats the symptom node connected to the parent requirement node as a parent, and the symptom node connected to the child requirement node as a child (S104-1; Yes, S104-2).

This process is repeated for all requirement nodes connected to symptom nodes in step S103 (S104-0, S104-3).

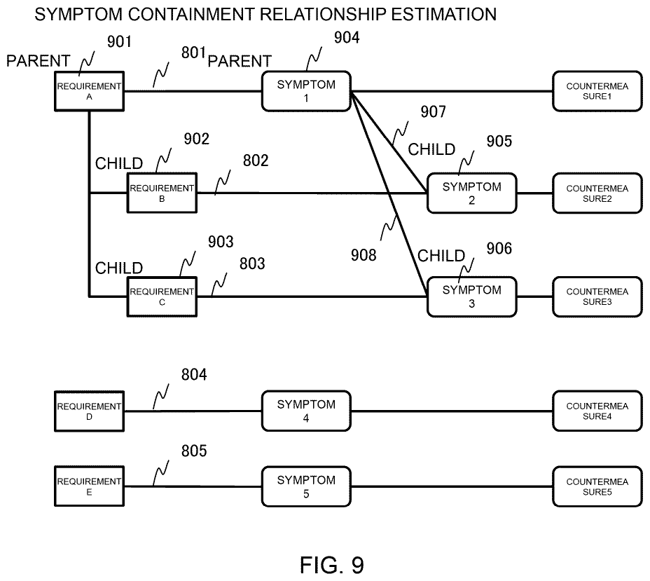

FIG. 9 is an example illustrating estimation of symptom inclusion relationships executed in step S104 according to Embodiment 1. In FIG. 9, requirement A node 901 is detected as the parent requirement node, and requirement B node 902 and requirement C node 903 are detected as child requirement nodes. Symptom 1 node 904 connected to requirement A node 901 is connected to symptom 2 node 905 connected to requirement B node 902, and to symptom 3 node 906 connected to requirement C node 903, via edges 907 and 908 shown in FIG. 9.

In step S105, the inclusion-relationship estimation and connection unit 120 first extracts component names from the text related to countermeasures stored in each countermeasure node (S105-1).

Next, among the component node data acquired in step S102, when a component node exists whose component name matches the extracted component name, the countermeasure node is connected to that component node (S105-2).

A countermeasure node for which no matching component node exists is not connected to any component node.

This processing is repeated for all countermeasure nodes (S105-0, S105-3).

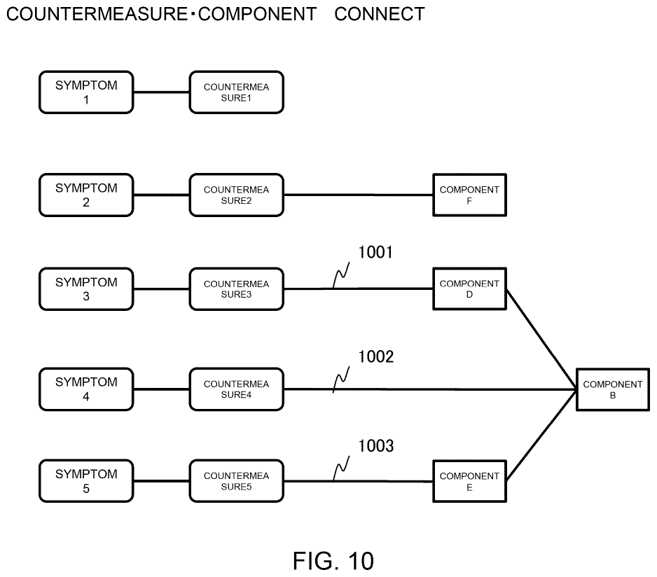

FIG. 10 is an example illustrating the connection between countermeasures and components executed in step S105 according to Embodiment 1. FIG. 10 shows an example in which component D is extracted from countermeasure 3, component B is extracted from countermeasure 4, and component E is extracted from countermeasure 5. In this case, the countermeasure 3 node is connected to the component D node, the countermeasure 4 node to the component B node, and the countermeasure 5 node to the component E node via edges 1001, 1002, and 1003, respectively, as shown in FIG. 10.

The sentence similarity between the component names extracted from the countermeasure nodes and the component names of the component nodes may be calculated, and the countermeasure node may be connected to the component node having the highest similarity score.

Here, as a method for connecting countermeasures and components, countermeasures 1-5 and components A-J shown in FIG. 4 may be input as prompts to a generative AI, and the generative AI may connect related countermeasures and components based on its learned knowledge. As the generative AI, various conventionally known generative AIs, including RAG (Retrieval-Augmented Generation), may be used, similar to the case of FIG. 8.

In step S106, the inclusion-relationship estimation and connection unit 120 detects, among the component nodes connected to countermeasure nodes in step S105, component nodes that include other component nodes. A component node that includes other component nodes is treated as a parent, and a component node that is included by another component node is treated as a child.

The inclusion-relationship estimation and connection unit 120 determines whether a component node includes another component. When a component node is determined to include another component, the unit connects the countermeasure node connected to the parent component node to the countermeasure node connected to the child component node.

The inclusion-relationship estimation and connection unit 120 treats the countermeasure node connected to the parent component node as a parent, and the countermeasure node connected to the child component node as a child (S106-1; Yes, S106-2).

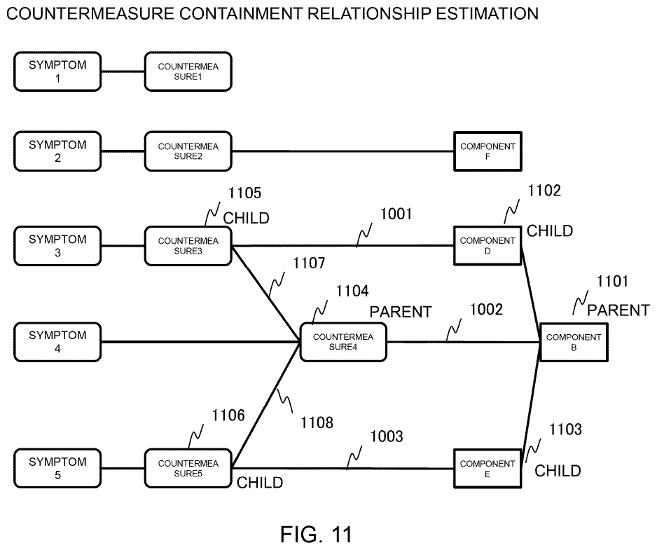

FIG. 11 is an example illustrating estimation of inclusion relationships among countermeasures executed in step S106 according to Embodiment 1. In FIG. 11, component B node 1101 is detected as the parent component node, and component D node 1102 and component E node 1103 are detected as child component nodes.

Countermeasure 4 node 1104 connected to component B node 1101 is connected to countermeasure 3 node 1105 connected to component D node 1102, and to countermeasure 5 node 1106 connected to component E node 1103, via edges 1107 and 1108 shown in FIG. 11.

In step S107, the inclusion-relationship estimation and connection unit 120 first detects symptom nodes (parents) determined in step S104. For all symptom nodes (children) connected to each detected parent symptom node, the unit connects the countermeasure node connected to the parent symptom node to the child symptom node. The connection weight is set as follows: the original connection between the parent symptom node and the countermeasure node is assigned a weight of 1, and the connection weight between the child symptom node and the countermeasure node connected to the parent symptom node is set to 0.5.

Next, in a similar manner, the inclusion-relationship estimation and connection unit 120 detects countermeasure nodes (parents) determined in step S106. For all countermeasure nodes (children) connected to each detected parent countermeasure node, the unit connects the symptom nodes connected to the parent countermeasure node to the child countermeasure node (S106-0, S106-3). The connection weight is set as follows: the original connection between the parent countermeasure node and the symptom node is assigned a weight of 1, and the connection weight between the child countermeasure node and the symptom node connected to the parent countermeasure node is set to 0.5.

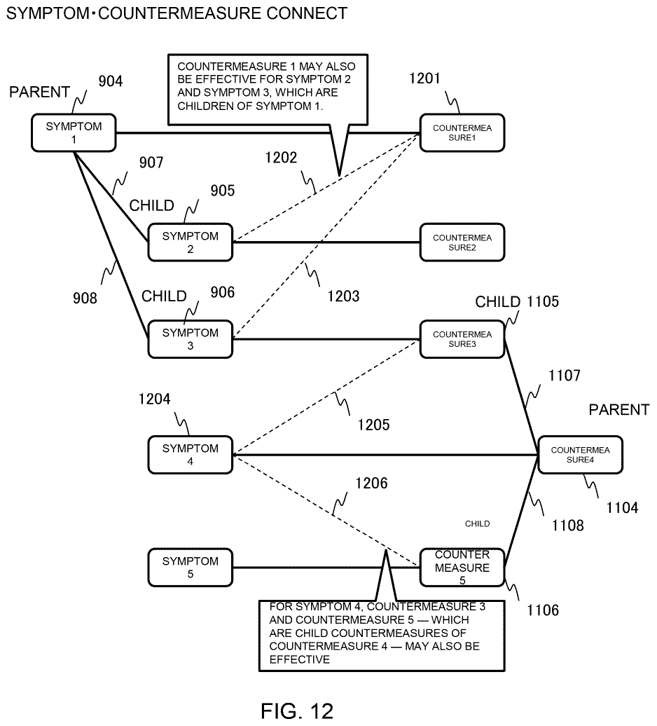

FIG. 12 is an example illustrating the connection between symptoms and countermeasures executed in step S107 according to Embodiment 1. In FIG. 12, symptom 2 node 905 and symptom 3 node 906, which are child nodes of symptom 1 node 904, are each connected to countermeasure 1 node 1201, which is connected to symptom 1 node 904, via edges 1202 and 1203 shown in FIG. 12.

The weights of edges 1202 and 1203 are set to 0.5. This is based on the concept that countermeasure 1, which is capable of resolving symptom 1 (parent), may also be effective for symptoms 2 and 3 (children). This processing is performed for all detected parent symptom nodes.

Next, countermeasure 3 node 1105 and countermeasure 5 node 1106, which are child nodes of countermeasure 4 node 1104, are connected to symptom 4 node 1204, which is connected to countermeasure 4 node 1104, via edges 1205 and 1206 shown in FIG. 12. This is based on the concept that symptom 4, which is resolved by countermeasure 4 (parent), may also be resolved by countermeasures 3 and 5 (children). This processing is performed for all detected parent countermeasure nodes.

Here, regarding the assignment of weights between a symptom (child) and a countermeasure connected to the symptom (parent), the weight does not need to be 0.5, and may be set arbitrarily by the user.

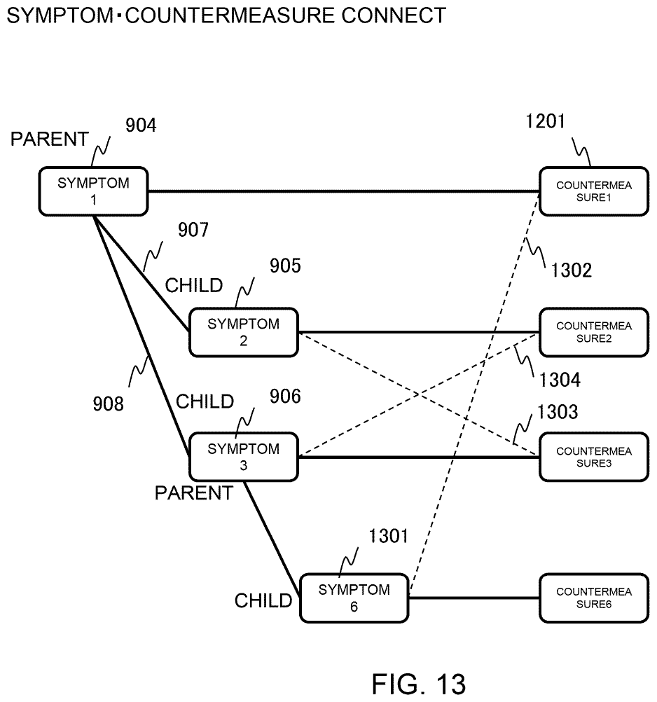

FIG. 13 is an example illustrating a case in which the parent-child relationships among symptom nodes span three hierarchical levels. When the requirement list of requirement data 300 shown in FIG. 3 has three levels instead of two, there may exist a node, such as symptom 3 node 906 in FIG. 13, that is both a child of symptom 1 node 904 and a parent of symptom 6 node 1301. In this case, symptom 6 node 1301 may be connected, via edge 1302 shown in FIG. 13, to countermeasure 1 node 1201, which is connected to symptom 3 node 906, which is in turn a child of symptom 1 node 904. In this case, symptom 1 node 904 corresponds to the first level, and symptom 6 node 1301 corresponds to the third level; therefore, the weight of edge 1302 is set to ⅓.

Similarly, when the requirement list has n hierarchical levels, an edge connecting to a node at the k-th level may be assigned a weight of 1/k. Alternatively, the weight of each edge may be set arbitrarily by the user.

Furthermore, as shown in FIG. 13, when multiple child symptoms exist for a parent symptom—e.g., symptom 2 node 905 and symptom 3 node 906 for symptom 1 node 904—countermeasure 3 node may be connected to symptom 2 node 905 and symptom 3 node 906 via edge 1303. Likewise, countermeasure 2 node may be connected to symptom 3 node 906 and symptom 2 node 905 via edge 1304.

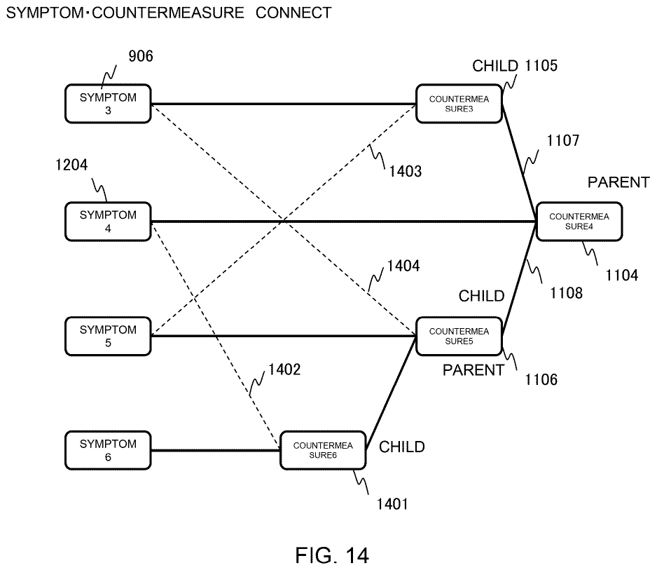

FIG. 14 is an example illustrating a case in which the parent-child relationships among countermeasure nodes span three hierarchical levels. When component data such as the component data 400 shown in FIG. 4 has three hierarchical levels, there may exist a node, such as countermeasure 5 node 1106 in FIG. 14, that is both a child of countermeasure 4 node 1104 and a parent of countermeasure 6 node 1401. In this case, countermeasure 6 node 1401 may be connected, via edge 1402 shown in FIG. 14, to symptom 4 node 1204, which is connected to countermeasure 5 node 1106, which is in turn a child of countermeasure 4 node 1104. In this case, countermeasure 4 node 1104 corresponds to the first level, and countermeasure 6 node 1401 corresponds to the third level; therefore, the weight of edge 1402 is set to ⅓. Similarly, when the component data has n hierarchical levels, an edge connecting to a node at the k-th level may be assigned a weight of 1/k. Alternatively, each edge weight may be set arbitrarily by the user.

Furthermore, as shown in FIG. 14, when multiple child countermeasures exist for a parent countermeasure—e.g., countermeasure 3 node 1105 and countermeasure 5 node 1106 for countermeasure 4 node 1104—symptom 5 node may be connected to countermeasure 3 node 1105 and countermeasure 5 node 1106 via edge 1403. Likewise, symptom 3 node 906 may be connected to countermeasure 5 node 1106 and countermeasure 3 node 1105 via edge 1404.

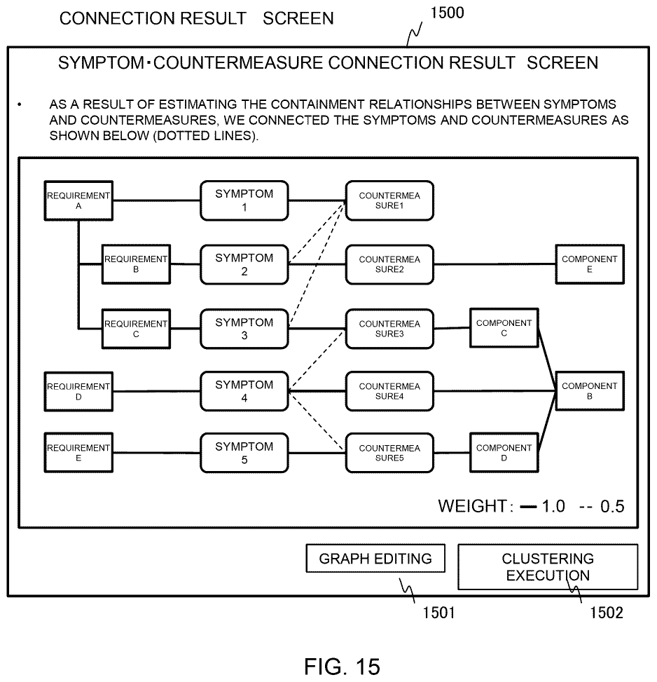

FIG. 15 is an example of a screen presenting the connection results between symptoms and countermeasures according to Embodiment 1. The graph-shaping unit 150 presents, on a symptom-countermeasure connection-result display screen 1500, the requirement-symptom connection results generated in steps S103 through S107, the component-countermeasure connection results, and the newly connected symptoms and countermeasures based on the estimated inclusion relationships.

On the symptom-countermeasure connection-result display screen 1500, the system may receive user operations such as freely adding or deleting nodes, or editing edge weights, by clicking button 1501.

After the user has reviewed the results (S108), clicking button 1502 issues an instruction to perform clustering (S109), upon which the clustering unit 130 begins the clustering process.

### Clustering Processing

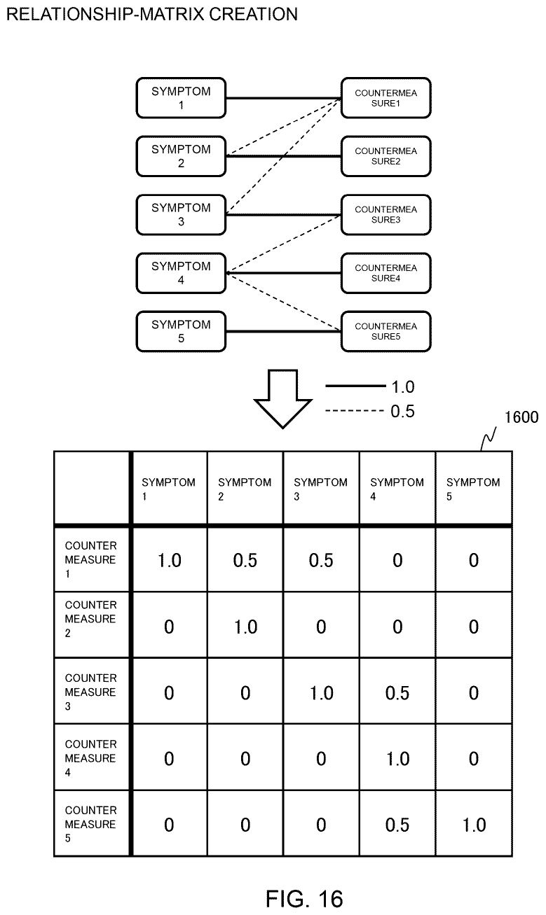

FIG. 16 is a diagram illustrating creation of a relationship matrix according to Embodiment 1.

In step S110, the clustering unit 130 creates a relationship matrix 1600 based on the symptom-countermeasure connection results obtained in step S107 or the symptom-countermeasure connection results edited by the user in step S108.

In creating the relationship matrix 1600, for example, symptoms are arranged along the horizontal axis and countermeasures along the vertical axis. When the number of symptom nodes is N and the number of countermeasure nodes is M, an N×M matrix is created. By storing, in each matrix element [i, j], the connection weight between symptom node (i) and countermeasure node (j), the relationship matrix is generated.

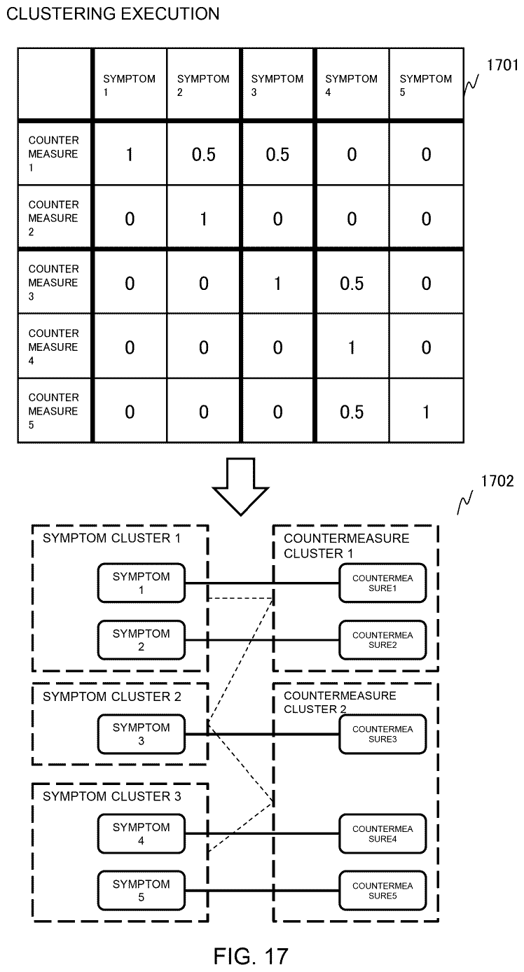

In step S111, the clustering unit 130 performs co-clustering on the relationship matrix 1600 created in step S110. FIG. 17 is an example illustrating clustering according to Embodiment 1. Through co-clustering, symptom clusters and countermeasure clusters are partitioned while taking into account the correspondences between symptoms and countermeasures, and a clustering matrix 1701 is output. Based on the clustering matrix 1701, symptom nodes belonging to each symptom cluster and countermeasure nodes belonging to each countermeasure cluster are output as clustering results 1702.

Here, as a method for reflecting the clustering results 1702 in the failure knowledge graph 143, cluster IDs may be created and appended to the respective nodes.

Alternatively, cluster nodes may be created and connected to the nodes belonging to each cluster.

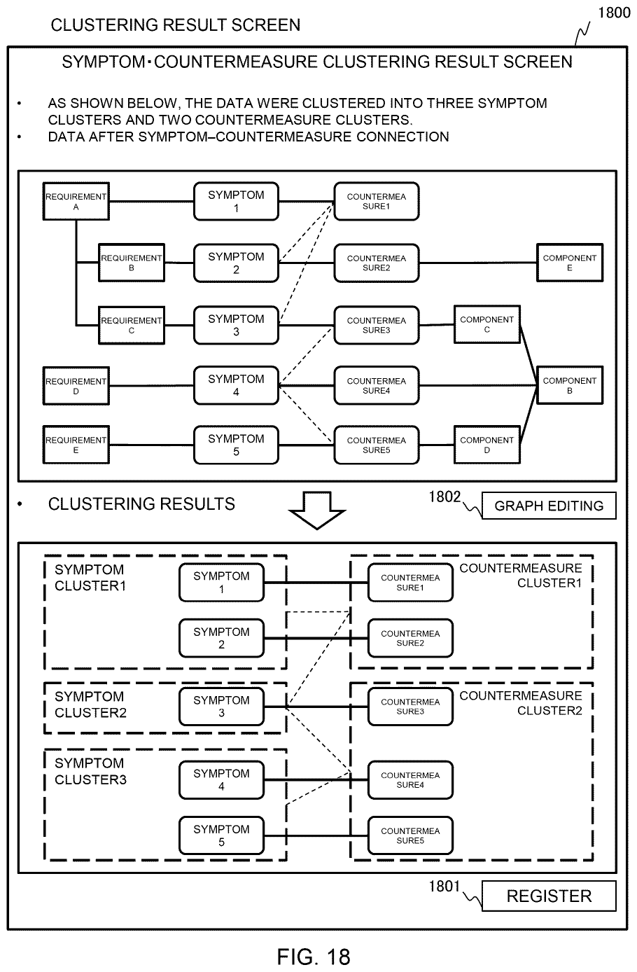

FIG. 18 is an example of a screen presenting the connection results between symptoms and countermeasures according to Embodiment 1. As a pre-clustering state, the symptom-countermeasure connection results reviewed by the user in step S108, as well as the co-clustering results executed based on those connection results, are presented on a symptom-countermeasure clustering-result display screen 1800.

On the symptom-countermeasure clustering-result display screen 1800, the user reviews the results and registers them into the failure knowledge graph 143 by clicking button 1801 to issue a registration instruction.

If the user reviews the results and determines that the obtained results are not desirable, the symptom-countermeasure clustering-result display screen 1800 may receive edits to the pre-clustering symptom-countermeasure connection results by allowing the user to click button 1802.

Although the embodiment above describes an implementation using co-clustering, any clustering method other than co-clustering may be used for steps S109 onward.

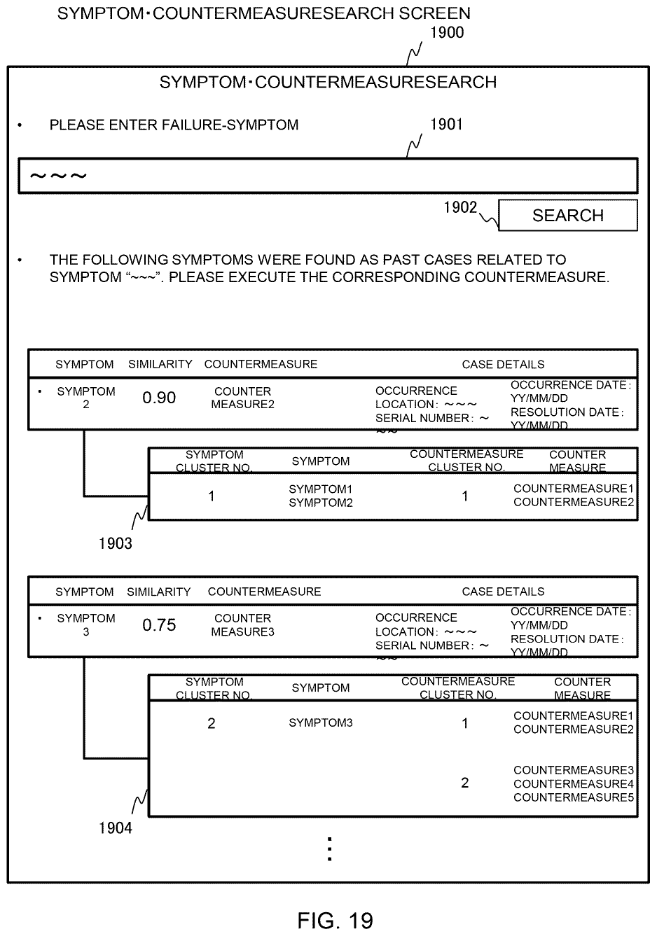

FIG. 19 is an example of a screen in which a user searches for failure symptoms and corresponding countermeasures using the symptom-countermeasure clustering results according to Embodiment 1. This screen 1900 (symptom-countermeasure search screen) is output by the input/output unit 110. The user first inputs text relating to a failure symptom into a text input box 1901. Then, by clicking a search button 1902, the system calculates the sentence similarity between the text of the symptom nodes of the failure knowledge graph 143 and the text entered in input box 1901, and presents, in descending order of similarity, each symptom node, the countermeasure nodes connected to each symptom node, and detailed information on cases included in the symptom node. The system may determine a threshold value for sentence similarity to control the display, or may predefine the number of displayed items. In FIG. 19, symptom 2 and symptom 3 are presented as similar symptoms. For symptom 2, information 1903 is displayed regarding the symptom cluster to which symptom 2 belongs and the countermeasure clusters connected to that symptom cluster. This allows the user to consider not only countermeasure 2 but also countermeasure 1 as potential solutions for symptom 2. Similarly, for symptom 3, based on information 1904 regarding the symptom cluster to which symptom 3 belongs and the countermeasure clusters connected to that symptom cluster, the user may consider not only countermeasure 3 but also countermeasures 1, 2, 4, and 5.

### Embodiment 2

A second embodiment of the present disclosure relates to performing a symptom-countermeasure search using the connection results between symptom nodes and countermeasure nodes obtained in step S107 of Embodiment 1. In Embodiment 1, after connecting the symptom and countermeasure nodes in step S107, clustering was performed, and the resulting clusters were used to search for failure symptoms and corresponding countermeasures. In Embodiment 2, a procedure is presented in which failure symptoms and corresponding countermeasures are searched using the symptom-countermeasure connection results before clustering is executed.

In Embodiment 2, steps S101 through S107 are the same as those in Embodiment 1.

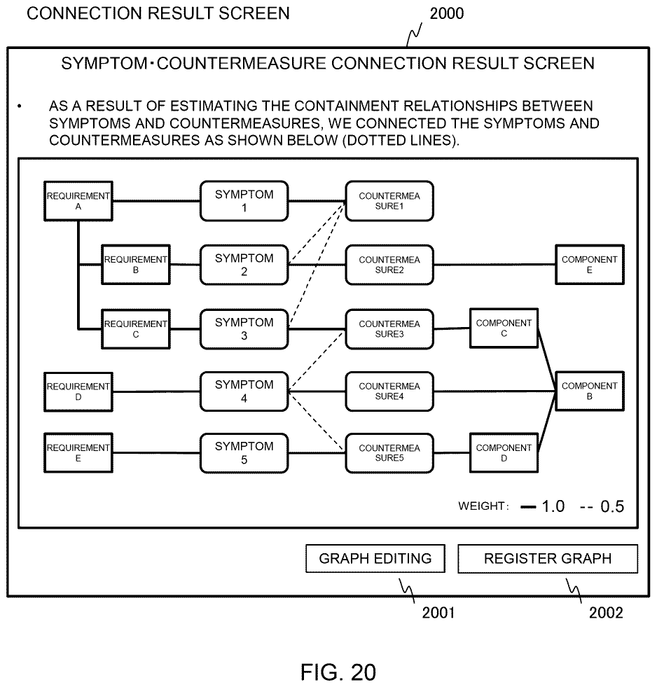

FIG. 20 is an example of a screen presenting the connection results between symptoms and countermeasures according to Embodiment 2. Similar to FIG. 15 described in Embodiment 1, a symptom-countermeasure connection-result display screen 2000 presents the requirement-symptom connection results generated in steps S103 through S107, the component-countermeasure connection results, and the newly connected symptoms and countermeasures based on the estimated inclusion relationships. By clicking button 2001, the system may receive user edits to the graph. Thereafter, by clicking button 2002, the graph is registered into the failure knowledge graph 143.

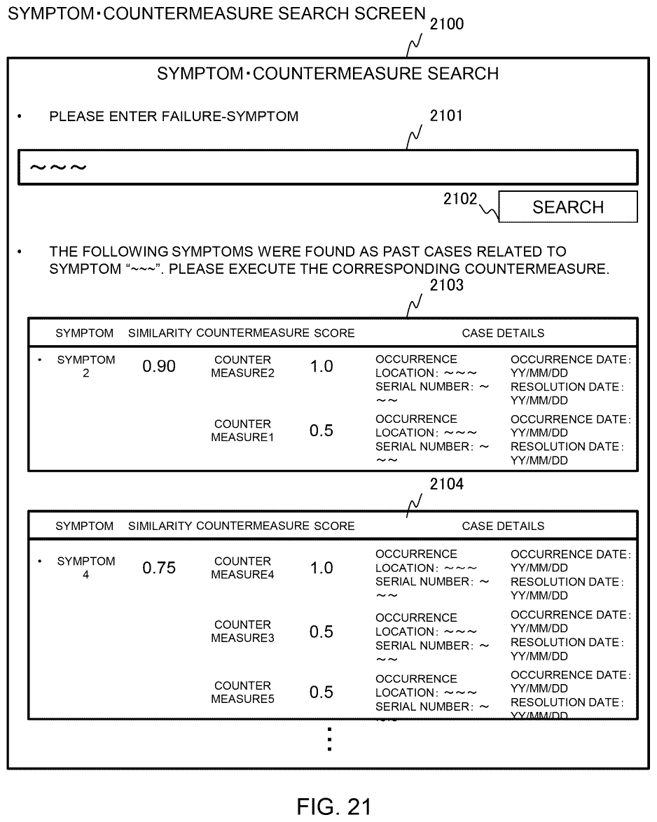

Next, based on the registered graph, the user searches for failure symptoms and corresponding countermeasures. FIG. 21 is an example of a screen for searching failure symptoms and their countermeasures using the symptom-countermeasure node connection results according to Embodiment 2.

On the symptom-countermeasure search screen 2100, the user first inputs text relating to a failure symptom into a text input box 2101. Then, by clicking a search button 2102, the system calculates the sentence similarity between the text of the symptom nodes in the failure knowledge graph 143 and the text entered by the user into the input box 2101. Based on the similarity rankings, the system presents each symptom node, the countermeasure nodes connected to each symptom node, and detailed data on the cases contained in each symptom node.

At this time, for each presented symptom, based on the graph registered in FIG. 20, countermeasure nodes connected to the symptom node and the edge weights are presented as scores. For example, in FIG. 21, for the data 2103 related to symptom 2, countermeasure 2 node (connected via an edge having a weight of 1.0) and countermeasure 1 node (connected via an edge having a weight of 0.5), both registered in FIG. 20, are presented. Similarly, for the data 2104 related to symptom 4 node, countermeasure 4 node (connected via an edge having a weight of 1.0) and countermeasure 3 node and countermeasure 5 node (each connected via an edge having a weight of 0.5) registered in FIG. 20 are presented.

As described above, it is possible to search for failure symptoms and corresponding countermeasures using the connection results between symptom nodes and countermeasure nodes without performing clustering.

While the embodiments have been described above with reference to the drawings, the knowledge management system in the present embodiment is, as described with reference to FIGS. 1 and 6-9, a knowledge management system (knowledge management system 100) for performing knowledge management by a computer comprising a processor and a memory. The processor is configured to receive inputs of a first data group (e.g., requirement data including requirements and assumed symptoms; see FIGS. 3 and 5) and a second data group (e.g., failure reports including symptoms and countermeasures; see FIGS. 2 and 5) (FIG. 6, S102); execute a first analysis process for analyzing a first inclusion relationship possessed by the first data group (e.g., requirements B and C being included in requirement A) (FIG. 5, S103-1, FIG. 7); execute a second analysis process for associating the analyzed first data group with the second data group based on the analyzed first inclusion relationship (e.g., associating requirement A with symptom 1, requirement B with symptom 2, and requirement C with symptom 3) (S103-2, FIG. 7, FIG. 8); and execute a third analysis process for analyzing a second inclusion relationship in the second data group based on the first inclusion relationship and the associations obtained through the second analysis process (e.g., that requirement B corresponding to symptom 2 is included in requirement A, and that requirement C corresponding to symptom 3 is included in requirement A) (S104-1, FIG. 7, FIG. 8). The processor is further configured to execute a first connection process that connects a new relationship between (i) the second data group included by the second inclusion relationship analyzed by the third analysis process(e.g., symptoms 2 and 3) and (ii) the second data group associated with the first data group including the first inclusion relationship analyzed by the first analysis process (e.g., symptom 1 associated with requirement A) (S104-2, FIG. 7, FIG. 9).

Accordingly, related data can be searched over a wider range by estimating inclusion relationships among data and connecting data while taking the inclusion relationships into account. For example, by creating a failure-response knowledge graph (FIG. 5) from failure reports (FIG. 2) and design documents (FIGS. 3 and 4), lead time can be reduced. Specifically, bottlenecks in manufacturing lead time caused by failure responses in adjustment processes can be eliminated, thereby improving operations when failures occur. Furthermore, for example, inclusion relationships among symptoms can be estimated from inclusion relationships among requirements, and new relationships among symptoms, such as those shown in FIG. 9, can be added, thereby enabling clustering that includes similar cases.

As described with reference to FIGS. 1, 6-7, and 10-11, the processor is further configured to receive an input of a third data group (e.g., component data including large components, medium components, and small components; see FIGS. 4 and 5) (FIG. 6, S102); execute a second connection process for connecting the second data group with the third data group related to the second data group (e.g., a component whose name matches a component name involved in a countermeasure) (S105, FIG. 7, FIG. 10); and execute a fourth analysis process for analyzing a third inclusion relationship possessed by the third data group connected by the second connection process (e.g., component B including component D and component E) (S106-1, FIG. 7, FIG. 10). The processor is further configured to execute a third connection process for connecting a new relationship between (i) the second data group (e.g., countermeasures 3 and 5) connected to the third data group (e.g., components D and E) included by the third inclusion relationship analyzed by the fourth analysis process and (ii) the second data group (e.g., countermeasure 4) connected to the third data group (e.g., component B) including the third inclusion relationship (S106-2, FIG. 7, FIG. 11).

Accordingly, for example, inclusion relationships among countermeasures can be estimated from inclusion relationships among components, and new relationships among countermeasures—such as those shown in FIG. 11—can be added. In addition to the new relationships among symptoms, this enables clustering that includes further similar cases.

As described with reference to FIGS. 6 and 17, the processor is further configured to create a relationship matrix indicating correspondences between the second data group and the third data group, and to perform clustering (S110, S111, FIG. 6, FIG. 17). As a result, clustering that includes similar cases can be performed easily. Even in situations where clustering based on conventional sentence similarity cannot appropriately group related items, similar cases can be clustered with high accuracy.

Specifically, because co-clustering cannot be executed using only the “symptoms” and “countermeasures” as described in failure reports, supplementary information representing similarities among symptoms or countermeasures (e.g., inclusion relationships among requirements or among components) is provided. By providing such supplementary information, relationships among nodes are estimated so that new relationships can be inferred from already-established relationships. Using the estimated relationships, co-clustering is performed. Accordingly, for example, when similarity is determined between one countermeasure and another countermeasure, it becomes easy to understand that a symptom resolved by the first countermeasure may also be resolved by the other countermeasure.

As further described with reference to FIGS. 7 and 8, in the second analysis process, the processor performs association by connecting the first data group and the second data group based on sentence similarity (S103-1, S103-2, FIG. 7). The processor then executes the clustering based on correspondence between the second data group associated with the first data group as described above and the third data group. This enables extraction of synonymous expressions of “symptoms” by taking into account the similarity of “countermeasures,” thereby resolving cases that cannot be classified solely on the basis of sentence similarity. In addition, even in cases where two sentences appear dissimilar at first glance but in fact describe similar “countermeasures,” the system can adopt such countermeasures to solve the problem.

As also described with reference to FIGS. 7 and 8, the processor inputs the received first data group and the second data group into a generative AI. Based on the first inclusion relationship in the first data group and the second inclusion relationship in the second data group, the generative AI generates a connection between the first data group and the second data group. The processor then executes the clustering based on the correspondence between the second data group, after being associated through the generated connection described above, and the third data group. This enables the problem to be solved with high accuracy based on the latest information learned by the generative AI.

As further described with reference to FIGS. 6 and 17, the processor receive as input the first data group including a requirements list (FIG. 3) in which specifications required for a product are structured and an assumed symptom list (FIG. 3) in which assumed symptoms expected to occur when each requirement is not satisfied are listed, the second data group including data (FIG. 2) relating to symptoms of failures and countermeasures implemented and the third data group including structured data (FIG. 4) representing the structure of components constituting the product. The processor estimates an inclusion relationship between the requirements and the assumed symptoms as the first inclusion relationship. The processor estimates the second inclusion relationship based on the estimated first inclusion relationship and correspondence with the failure-related symptoms. And the processor connects, and executes the clustering based on, the second data group (e.g., Countermeasure 3, Countermeasure 5) connected to the third data group (e.g., Product D, Component E) included by the third inclusion relationship based on the estimated second inclusion relationship and the second data group (e.g., Countermeasure 4) connected to the third data group (e.g., Component B) including the third inclusion relationship. This enables relationships among nodes—each data group including the requirements list, the assumed symptom list, the countermeasure-related data, and the structured component-structure data—to be inferred from relationships that have already been determined, and allows co-clustering to be executed using the inferred relationships.

As further described with reference to FIG. 17, the processor executes the clustering by generating a relationship matrix reflecting the relationship between the symptoms of the failures included in the second data group and the implemented countermeasures. This makes it possible to easily perform clustering that includes similar cases reflecting the relationships between the symptoms of the failures and the implemented countermeasures.

As further described with reference to FIG. 9, the processor estimates the relationship between the structured requirements included in the first data group and the failure-related symptoms included in the second data group, and to estimate, from the first inclusion relationship, an inclusion relationship relating to the failure-related symptoms among the second inclusion relationship. This enables broader retrieval of relevant data by estimating the inclusion relationships of the structured requirements and the failure-related symptoms, and by connecting data while taking such inclusion relationships into account.

As further described with reference to FIG. 9, the processor estimates the relationship between the structured components in the third data group and the implemented countermeasures included in the second data group, and to estimate, from the third inclusion relationship, an inclusion relationship relating to the countermeasures among the second inclusion relationship. This enables broader retrieval of relevant data by estimating the inclusion relationships of the structured components and the implemented countermeasures, and by connecting data while taking such inclusion relationships into account.

The present invention is not limited to the embodiments described above. In the implementation stage, the invention may be embodied by modifying the components within a scope that does not depart from the spirit of the invention, or by appropriately combining a plurality of components disclosed in the embodiments described above.

What is claimed is:

1. A knowledge management system for performing knowledge management by a computer comprising a processor and a memory, wherein the processor is configured to:
receive inputs of a first data group and a second data group;
execute a first analysis process for analyzing a first inclusion relationship possessed by the first data group;
execute a second analysis process for associating the analyzed first data group with the second data group based on the analyzed first inclusion relationship;
execute a third analysis process for analyzing a second inclusion relationship in the second data group execute a third analysis process for analyzing a second inclusion relationship in the second data group based on the first inclusion relationship and the associations obtained through the second analysis process; and
execute a first connection process that connects a new relationship between (i) the second data group included by the second inclusion relationship analyzed by the third analysis process and (ii) the second data group associated with the first data group including the first inclusion relationship analyzed by the first analysis process.

2. The knowledge management system according to claim 1,
wherein the processor is further configured to:
receive an input of a third data group;
execute a second connection process for connecting the second data group with the third data group related to the second data group;
execute a fourth analysis process for analyzing a third inclusion relationship possessed by the third data group connected by the second connection process; and
execute a third connection process for connecting a new relationship between (i) the second data group connected to the third data group included by the third inclusion relationship analyzed by the fourth analysis process and (ii) the second data group connected to the third data group including the third inclusion relationship.

3. The knowledge management system according to claim 2,
wherein the processor is configured to create a relationship matrix indicating correspondence between the second data group and the third data group, and to perform clustering.

4. The knowledge management system according to claim 3,
wherein, in the second analysis process, the processor performs the association by connecting the first data group and the second data group based on sentence similarity,
and executes the clustering based on correspondence between the second data group associated with the first data group and the third data group.

5. The knowledge management system according to claim 3,
wherein the processor is configured to:
input the received first data group and the second data group into a generative AI;
execute the clustering based on correspondence between the second data group associated, via a connection generated by the generative AI based on the first inclusion relationship in the first data group and the second inclusion relationship in the second data group, and the third data group.

6. The knowledge management system according to claim 3,
wherein the processor is configured to:
receive as input the first data group including a requirements list in which specifications required for a product are structured and an assumed symptom list in which assumed symptoms expected to occur when each requirement is not satisfied are listed, the second data group including data relating to symptoms of failures and countermeasures implemented and the third data group including structured data representing the structure of components constituting the product;
estimate an inclusion relationship between the requirements and the assumed symptoms as the first inclusion relationship;
estimate the second inclusion relationship based on the estimated first inclusion relationship and correspondence with the failure-related symptoms; and
connect, and execute the clustering based on, the second data group connected to the third data group included by the third inclusion relationship based on the estimated second inclusion relationship and the second data group connected to the third data group including the third inclusion relationship.

7. The knowledge management system according to claim 6,
wherein the processor is configured to execute the clustering by generating the relationship matrix reflecting the relationship between the symptoms of the failures included in the second data group and the implemented countermeasures.

8. The knowledge management system according to claim 6,
wherein the processor is configured to estimate a relationship between the structured requirements included in the first data group and the failure-related symptoms included in the second data group, and to estimate, from the first inclusion relationship, an inclusion relationship relating to the failure-related symptoms among the second inclusion relationship.

9. The knowledge management system according to claim 6,
wherein the processor is configured to estimate a relationship between the structured components included in the third data group and the implemented countermeasures included in the second data group, and to estimate, from the third inclusion relationship, an inclusion relationship relating to the countermeasures among the second inclusion relationship.

10. A data-connection method performed by a knowledge management system that performs knowledge management by a computer,
the method comprising:
receiving inputs of a first data group and a second data group;
executing a first analysis process that analyzes a first inclusion relationship possessed by the first data group;
executing a second analysis process that associates the first data group, in which the first inclusion relationship has been analyzed, with the second data group;
executing a third analysis process that analyzes a second inclusion relationship in the second data group based on the first inclusion relationship and a correspondence established by the second analysis process; and
executing a first connection process that connects a new relationship between (i) the second data group included by the second inclusion relationship analyzed by the third analysis process and (ii) the second data group associated with the first data group including the first inclusion relationship analyzed by the first analysis process.
